(19) United States
(12) Patent Application Publication
(10) Pub. No.: US 2020/0306708 A1
(43) Pub. Date: Oct. 1, 2020

(54) AUTOMATIC CHARGING AND MIXING DEVICE FOR OINTMENT

(71) Applicant: SHANDONG FANGMING PHARMACY GROUP CO., LTD., Heze City (CN)

(72) Inventors: Shuangjun WU, Heze City (CN); Yanru Xu, Heze City (CN); Song Wang, Heze City (CN); Xin He, Heze City (CN); Xin Chen, Heze City (CN); Cuiling Liu, Heze City (CN)

(21) Appl. No.: 16/689,818

(22) Filed: Nov. 20, 2019

(30) Foreign Application Priority Data
Mar. 29, 2019 (CN) 201910247249.5

(51) Int. Cl. B01F 15/00; B01F 15/02; B01F 15/04

(52) U.S. Cl. CPC B01F 15/00415; B01F 15/0216; B01F 2215/0032; B01F 15/0441; B01F 15/0247

(57) ABSTRACT

An automatic charging and mixing device for an ointment is provided, comprising a box body, and a platform provided with a rotating seat. The center of the rotating seat is provided with a through hole. The interior of the box body is provided with a stepping motor, and the stepping motor matches the through hole through a coupler. A plurality of feed ports and a plurality of material feeding assemblies are provided on the platform at intervals circumferentially with the through hole as the circle center. The material feeding assembly comprises a telescopic cylinder, a plunger pump, a limiting rod, and a lifting assembly. The device is used to prepare the ointment by placing all raw materials into a mixing drum in sequence according to a set time and sequence

### TECHNICAL FIELD

The present invention relates to an automatic charging and mixing device for an ointment.

### BACKGROUND

An ointment refers to a semi-solid preparation for external use that has a certain consistency and prepared by uniformly mixing drugs and a suitable base. Common bases are classified into greasing, water-soluble, and emulsion bases.

Ointments can be classified into a solution type and a suspension type due to different dispersion states of drugs in the base. The solution type ointment is prepared by dissolving or co-solving drugs in the base or base components, while the suspension type ointment is prepared by evenly dispersing drug powder in the base.

In the existing preparation process of ointments, all kinds of raw materials need to be mixed for preparation, each raw material needs to be taken out from a raw material box in sequence according to a set proportion, and then the raw materials are mixed. However, due to the specific requirement of each raw material in the placement order or placement time node, a required ointment cannot be obtained by only simply mixing all kinds of the raw materials.

### SUMMARY OF THE INVENTION

An automatic charging and mixing device for an ointment is provided in embodiments of the present invention. The device is reasonable in structure design, and can prepare the ointment by placing all kinds of raw materials in a mixing drum in sequence according to set time nodes and placement order, so that the required ointment can be obtained rapidly and efficiently. The device is easy to operate, and the problems existing in the prior art are solved.

The technical solution adopted by the present invention to solve the above technical problem is as follows.

An automatic charging and mixing device for an ointment, comprising a box body, and a platform disposed at the top of the box body, wherein a rotating seat is disposed at a central position of the platform, the center of the rotating seat is provided with a through hole, the interior of the box body is provided with a stepping motor of which an output shaft is disposed upward vertically, the output shaft of the stepping motor is connected to a rotating shaft matching the through hole through a coupler, a plurality of feed ports are provided on the platform at intervals circumferentially with the through hole as the circle center, a material feeding assembly is provided on the platform corresponding to each feed port, the material feeding assembly comprises a telescopic cylinder of which a piston rod is disposed to face the through hole, the piston rod of the telescopic cylinder is provided with a vertically downward plunger pump matching the corresponding feed port, an inner side of the platform corresponding to each feed port is provided with a limiting rod, the rotating shaft is further provided with a lifting assembly matching the feed ports, the lifting assembly comprises a lifting plate disposed on the rotating shaft, the lifting plate is provided with a plurality of mixing drums corresponding to the feed ports, the top of each mixing drum is provided with a limiting hole matching the corresponding limiting rod, the lifting plate is further provided with a telescopic connecting rod, the rotating seat is provided with an arc-shaped slot matching the telescopic connecting rod, the platform is provided with a controller and a timer, and the controller is connected to the telescopic cylinder, the plunger pump, the stepping motor, and the timer in sequence.

The telescopic cylinder is connected to the plunger pump by connecting plates disposed oppositely, an inner side of each connecting plate is provided with a groove, two sides of each plunger pump are provided with sliding rails matching the grooves, each sliding rail is provided with a plurality of locking holes at intervals, and each connecting plate is provided with locking bolts matching the locking holes.

The arc-shaped slot is at an angle of 180°, and the arc-shaped slot is provided with a scale line. The rotating seat is provided with a plurality of photoelectric sensors of which probes are disposed outward, and the platform is provided with a plurality of signal receiving plates cooperating with the photoelectric sensors.

The signal receiving plate is an arc-shaped plate, and the center of the arc-shaped plate is at the through hole.

Each photoelectric sensor is mounted on the rotating seat by a fixing slot.

The platform is provided with a time-delay relay which is connected to the controller and the stepping motor.

The box body is provided with an ultraviolet disinfection lamp and a thermostat, and the box body is further provided with a temperature sensor cooperating with the thermostat.

The controller is connected to the timer, the time-delay relay, the temperature sensor, and the photoelectric sensor in sequence by input pins, the controller is connected to the plunger pump, the telescopic cylinder, the ultraviolet disinfection lamp, the thermostat, and the stepping motor in sequence by output pins, and the controller is provided with a comparator and a trigger that are electrically connected to each other.

The model of the controller is STM32F103, the model of the timer is DS1302, the model of the temperature sensor is PT-100, the model of the photoelectric sensor is OH-1021, the model of the comparator is LT1719, and the trigger is an oracle trigger.

In the present invention, by use of the above structure, a rotating seat is rotated by a stepping motor to add all kinds of raw materials into a mixing drum in sequence for preparing an ointment, and the controller records a placement time node of each raw material by a timer to control the stepping motor to be rotated to a corresponding material feeding assembly at a corresponding time node to carry out the material feeding. The arc groove and the telescopic connecting rod enable the stroke of the stepping motor to be more accurate, so that the plunger pump is aligned with the mixing drum in the material feeding process to prevent inaccurate feeding amounts of the raw materials. The comparator and the trigger in the controller cooperate with the photoelectric sensor and the temperature sensor on the platform to further ensure the accuracy of the stroke of the stepping motor. The plunger pump is placed in the groove on the connecting plate of the telescopic cylinder, and the position of the plunger pump can be adjusted, which is convenient for the material feeding and has the advantages of being easy to operate, fast and efficient.

### DESCRIPTION OF THE DRAWINGS

FIG. 1 is a schematic structural diagram according to the present invention.

FIG. 2 is a top view of FIG. 1.

FIG. 3 is a schematic structural diagram of a lifting assembly according to the present invention.

FIG. 4 is a schematic structural diagram of the top of a mixing drum according to the present invention.

FIG. 5 is a schematic structural diagram of a telescopic cylinder and a plunger pump according to the present invention.

FIG. 6 is a schematic structural diagram of a plunger pump according to the present invention.

FIG. 7 is an electrical schematic diagram according to the present invention.

In the figures, 1. box body, 2. platform, 3. rotating seat, 4. through hole, 5. stepping motor, 6. coupler, 7. rotating shaft, 8. feeding port, 9. telescopic cylinder, 10. plunger pump, 11. limiting rod, 12. lifting plate, 13. mixing drum, 14. limiting hole, 15. telescopic connecting rod, 16. arc-shaped slot, 17. controller, 18. timer, 19. connecting plate, 20. groove, 21. sliding rail, 22. locking hole, 23. locking bolt, 24. photoelectric sensor, 25. signal receiving plate, 26. fixing slot, 27. time-delay relay, 28. ultraviolet disinfection lamp, 29. thermostat, 30. temperature sensor.

### DETAILED DESCRIPTION

In order to describe the technical characteristics of the solution clearly, the present invention is illustrated in detail in the following through specific implementations and with reference to the accompanying drawings.

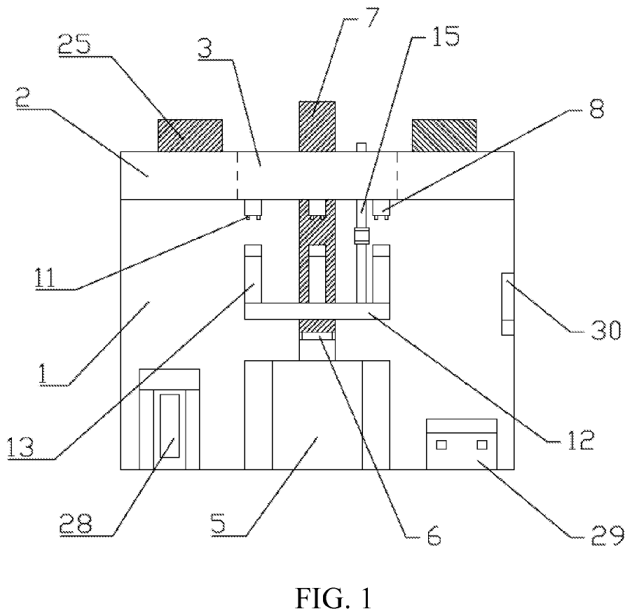

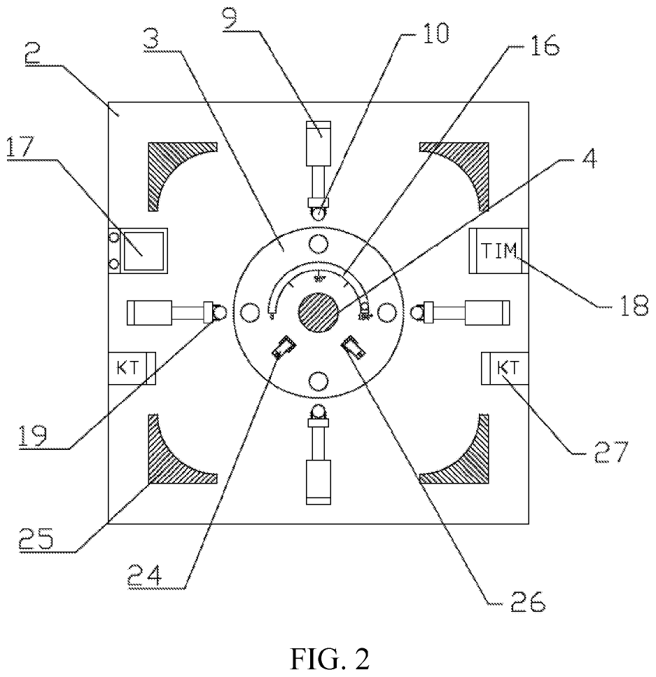

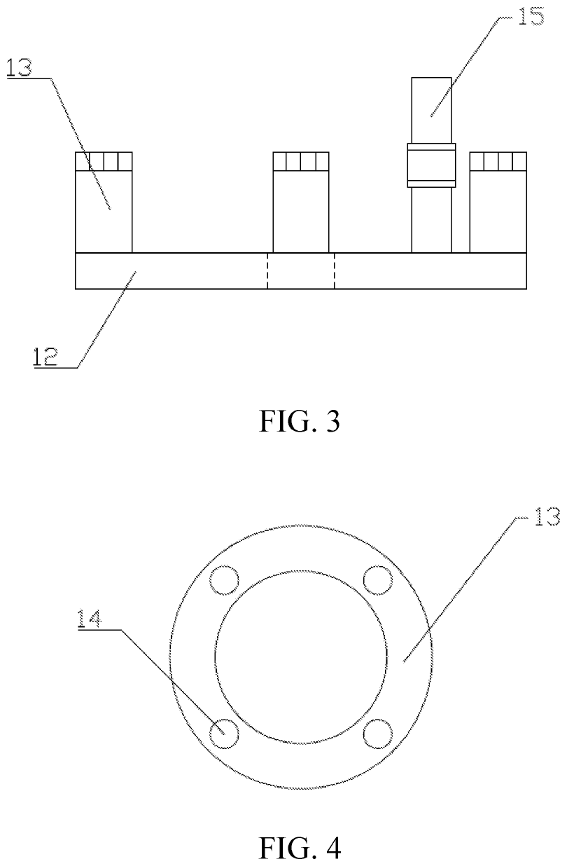

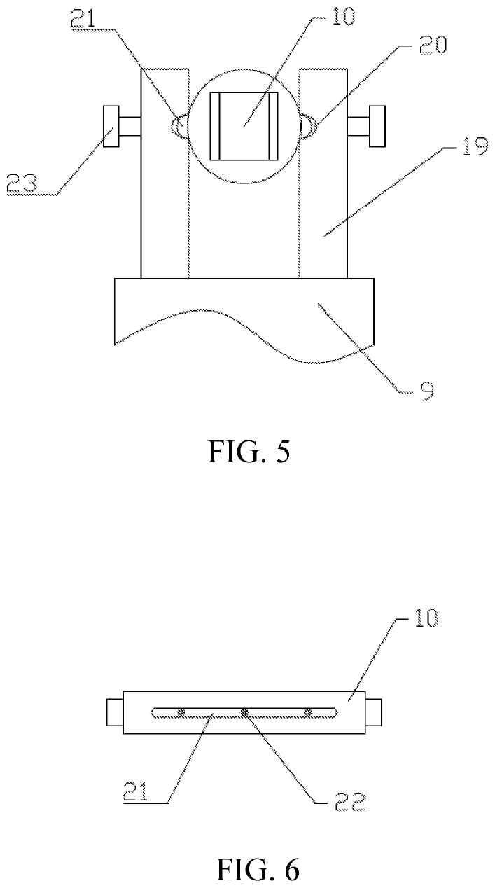

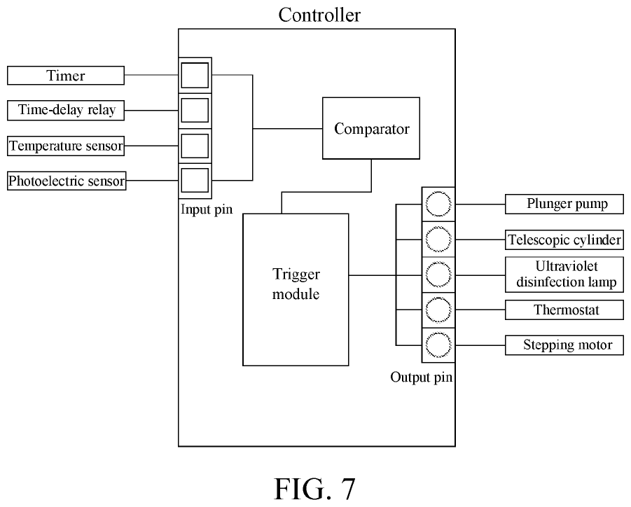

As shown in FIG. 1 to FIG. 7, an automatic charging and mixing device for an ointment includes a box body 1, and a platform 2 disposed at the top of the box body 1. A rotating seat 3 is disposed at a central position of the platform 2, and the center of the rotating seat 3 is provided with a through hole 4. The interior of the box body 1 is provided with a stepping motor 5 of which an output shaft is disposed upward vertically. The output shaft of the stepping motor 5 is connected to a rotating shaft 7 matching the through hole 4 through a coupler 6. A plurality of feed ports 8 are provided on the platform 2 at intervals circumferentially with the through hole 4 as the circle center. A material feeding assembly is provided on the platform 2 corresponding to each feed port 8, and the material feeding assembly includes a telescopic cylinder 9 of which a piston rod is disposed to face the through hole 4. The piston rod of the telescopic cylinder 9 is provided with a vertically downward plunger pump 10 matching the corresponding feed port 8. An inner side of the platform 2 corresponding to each feed port 8 is provided with a limiting rod 11. The rotating shaft 7 is further provided with a lifting assembly matching the feed ports 8, and the lifting assembly includes a lifting plate 12 disposed on the rotating shaft 7. The lifting plate 12 is provided with a plurality of mixing drums 13 corresponding to the feed ports 8. The top of each mixing drum 13 is provided with a limiting hole 14 matching the corresponding limiting rod 11. The lifting plate 12 is further provided with a telescopic connecting rod 15. The rotating seat 3 is provided with an arc-shaped slot 16 matching the telescopic connecting rod 15. The platform 2 is provided with a controller 17 and a timer 18, and the controller 17 is connected to the telescopic cylinder 9, the plunger pump 10, the stepping motor 5, and the timer 18 in sequence.

The telescopic cylinder 9 is connected to the plunger pump 10 by connecting plates 19 disposed oppositely, and an inner side of each connecting plate 19 is provided with a groove 20. Two sides of the plunger pump 10 are provided with sliding rails 21 matching the grooves 20. Each sliding rail 21 is provided with a plurality of locking holes 22 at intervals, and each connecting plate 19 is provided with locking bolts 23 matching the locking holes 22.

The arc-shaped slot 16 is at an angle of 180°, and the arc-shaped slot 16 is provided with a scale line.

The rotating seat 3 is provided with a plurality of photoelectric sensors 24 of which probes are disposed outward, and the platform 2 is provided with a plurality of signal receiving plates 25 matching the photoelectric sensors 24.

The signal receiving plate 25 is an arc-shaped plate, and the center of the arc-shaped plate is at the through hole 4.

Each photoelectric sensor 24 is mounted on the rotating seat 3 by a fixing slot 26.

The platform 2 is provided with a time-delay relay 27 which is connected to the controller 17 and the stepping motor 5.

The box body 1 is provided with an ultraviolet disinfection lamp 28 and a thermostat 29, and the box body 1 is further provided with a temperature sensor 30 matching the thermostat 29.

The controller 17 is connected to the timer 18, the time-delay relay 27, the temperature sensor 30 and the photoelectric sensor 24 in sequence by input pins, the controller 17 is connected to the plunger pump 10, the telescopic cylinder 9, the ultraviolet disinfection lamp 28, the thermostat 29, and the stepping motor 5 in sequence by output pins, and the controller 17 is provided with a comparator and a trigger that are electrically connected to each other.

The Model of the controller 17 is STM32F103, the model of the timer 18 is DS1302, the model of the temperature sensor 30 is PT-100, the model of the photoelectric sensor 24 is OH-1021, the model of the comparator is LT1719, and the trigger is an oracle trigger.

In use, all kinds of raw materials are placed into the plunger pump 10 at first, the timer 18 records a placement time node of each raw material, the controller 17 records a material feeding proportion of each raw material and sends an instruction to the stepping motor 5, the stepping motor 5 is operated to drive the rotating seat 3 to rotate, and the feeding port 8 is aligned with the material feeding port of the plunger pump 10. The arc-shaped slot 16 and the telescopic connecting rod 15 cooperate with each other so that the action stroke of the stepping motor 5 is more accurate. During the operation of the rotating seat 3, the photoelectric sensor 24 cooperates with the signal receiving plate 25, and the stroke of the stepping motor 5 is further verified according to a change in the distance between the photoelectric sensor 24 and the signal receiving plate 25. The controller 17 receives a change signal of the photoelectric sensor 24 and sends an instruction to the stepping motor 5 to finely tune the motion stroke. The time-delay relay 27 can provide a buffer time for the action of the stepping motor 5. After the feeding port 8 is moved in place, the telescopic connecting rod 15 is operated to drive the lifting plate 12 to rise. The limiting hole 14 on the top of the mixing drum 13 matches the limiting rod 11 on the feeding port 8. The mixing drum 13 is clamped on the feeding port 8 so that the discharge amount of the plunger pump 10 is accurate. The controller 17 sends an instruction to the telescopic cylinder 9 to drive the plunger pump 10 to move to the feeding port 8. The plunger pump 10 adjusts the position of the plunger pump 10 on the connecting plate 19 through the sliding rails 21, the locking holes 22, and the locking bolts 23 to facilitate the material feeding. The comparator and the trigger inside the controller 17 cooperate with each other, so that the controller 17 adjusts the actions of the telescopic cylinder 9, the plunger pump 10, and the stepping motor 5 according to data fed back by the timer 18, the time-delay relay 27, the temperature sensor 30, and the photoelectric sensor 24, thereby performing the material feeding operation more conveniently and accurately. After a first kind of raw materials has been added, other raw materials are injected continuously according to the above steps, and after all the raw materials have been added, the telescopic connecting rod 15 is dropped, the mixing drum 13 is placed in the box body 1. The ultraviolet disinfection lamp 28 and the thermostat 29 cooperate with each other to create a thermostatic sterile storage environment, and after the mixed charging is completed, the mixing drum 13 is stored for the next step of drug processing and preparation.

The above specific implementations cannot be used as limitations to the protection scope of the present invention. For those skilled in the art, any alternative improvements or changes made to the implementations of the present invention are all encompassed in the protection scope of the present invention.

Contents not described in detail in the present invention are all common technologies for those skilled in the art.

1. An automatic charging and mixing device for an ointment, comprising a box body, and a platform disposed at the top of the box body, wherein a rotating seat is disposed at a central position of the platform, the center of the rotating seat is provided with a through hole, the interior of the box body is provided with a stepping motor of which an output shaft is disposed upward vertically, the output shaft of the stepping motor is connected to a rotating shaft matching the through hole through a coupler, a plurality of feed ports are provided on the platform at intervals circumferentially with the through hole as the circle center, a material feeding assembly is provided on the platform corresponding to each feed port, the material feeding assembly comprises a telescopic cylinder of which a piston rod is disposed to face the through hole, the piston rod of the telescopic cylinder is provided with a vertically downward plunger pump matching the corresponding feed port, an inner side of the platform corresponding to each feed port is provided with a limiting rod, the rotating shaft is further provided with a lifting assembly matching the feed ports, the lifting assembly comprises a lifting plate disposed on the rotating shaft, the lifting plate is provided with a plurality of mixing drums corresponding to the feed ports, the top of each mixing drum is provided with a limiting hole matching the corresponding limiting rod, the lifting plate is further provided with a telescopic connecting rod, the rotating seat is provided with an arc-shaped slot matching the telescopic connecting rod, the platform is provided with a controller and a timer, and the controller is connected to the telescopic cylinder, the plunger pump, the stepping motor, and the timer in sequence.

2. The device of claim 1, wherein the telescopic cylinder is connected to the plunger pump by connecting plates disposed oppositely, an inner side of each connecting plate is provided with a groove, two sides of each plunger pump are provided with sliding rails matching the grooves, each sliding rail is provided with a plurality of locking holes at intervals, and each connecting plate is provided with locking bolts matching the locking holes.

3. The device of claim 1, wherein the arc-shaped slot is at an angle of 180°, and the arc-shaped slot is provided with a scale line.

4. The device of claim 1, wherein the rotating seat is provided with a plurality of photoelectric sensors of which probes are disposed outward, and the platform is provided with a plurality of signal receiving plates cooperating with the photoelectric sensors.

5. The device of claim 4, wherein the signal receiving plate is an arc-shaped plate, and the center of the arc-shaped plate is at the through hole.

6. The device of claim 4, wherein each photoelectric sensor is mounted on the rotating seat by a fixing slot.

7. The device of claim 1, wherein the platform is provided with a time-delay relay which is connected to the controller and the stepping motor.

8. The device of claim 1, wherein the box body is provided with an ultraviolet disinfection lamp and a thermostat, and the box body is further provided with a temperature sensor cooperating with the thermostat.

9. The device of claim 8, wherein the controller is connected to the timer, the time-delay relay, the temperature sensor, and the photoelectric sensor in sequence by input pins, the controller is connected to the plunger pump, the telescopic cylinder, the ultraviolet disinfection lamp, the thermostat, and the stepping motor in sequence by output pins, and the controller is provided with a comparator and a trigger that are electrically connected to each other.

10. The device of claim 9, wherein the model of the controller is STM32F103, the model of the timer is DS1302, the model of the temperature sensor is PT-100, the model of the photoelectric sensor is OH-1021, the model of the comparator is LT1719, and the trigger is an oracle trigger.
